(19) United States
(12) Patent Application Publication
(10) Pub. No.: US 2025/0005561 A1
(43) Pub. Date: Jan. 2, 2025

(54) Currency Exchange (FX) Rate Targets Automation for Payments

(71) Applicant: Stampli Ltd., Tel Aviv-Yafo (IL)

(72) Inventors: Eyal Moshe Feldman, Sunnyvale, CA (US); Shane Brandon Hamby, San Carlos, CA (US)

(21) Appl. No.: 18/757,362

(22) Filed: Jun. 27, 2024

Related U.S. Application Data
(60) Provisional application No. 63/510,568, filed on Jun. 27, 2023.

(51) Int. Cl. G06Q 20/38

(52) U.S. Cl. CPC G06Q 20/381

(57) ABSTRACT

A system receives a first target value for a maximum loss rate at which a machine learning model performs an action, wherein the target loss rate at which the value is below a pre-determined threshold. The system receives a second target value for a minimum gain rate at which a machine learning model performs an action, wherein the target gain rate at which the value is above a pre-determined threshold. The system receives a set of events and a set of weights for the set of events. The system adjusts the set of weights for the set of events by applying a decay function to reduce the weight value of an event over time. The system may predict a time at which the machine learning model outputs a target value, wherein the target value is the maximum loss rate or the minimum gain rate.

### CROSS REFERENCE TO RELATED APPLICATION

This application claims a benefit of, and priority to, U.S. Patent Application No. 63/510,568, filed Jun. 27, 2023, the contents of which is incorporated by reference herein in its entirety.

### TECHNICAL FIELD

The disclosure generally relates to the field of real-time data optimization in exchange rates.

### BACKGROUND

The process of predicting when a target exchange rate between two currencies will occur is an arduous and laborious task often resulting in errors or inconsistency based on analysis of that data. Current systems heavily rely on manual inspection and monitoring to predict when an exchange rate between two currencies is a target exchange rate. An exchange rate between two currencies is a dynamic and constantly fluctuating value that may be influenced by various factors and events. Manual inspection and monitoring can be time-consuming, labor intensive, and prone to human error or biases. This makes it difficult to obtain accurate rate for which it close to optimal to exchange a currency.

### BRIEF DESCRIPTION OF THE DRAWINGS

Figure (FIG. 1 is a block diagram illustrating an example system environment, in accordance with some embodiments.

FIG. 2 includes block diagrams illustrating various components of an example computing server, in accordance with some embodiments.

FIG. 3 is a flowchart illustrating an example process for a predictive model, in accordance with some embodiments.

FIG. 4 is a flowchart illustrating an example process for an automated optimization engine, in accordance with some embodiments.

FIG. 5 is a block diagram illustrating components of an example computing machine, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method, and computer-readable storage medium includes a configuration for a predictive model that estimates an optimal time at which a target foreign exchange (FX) rate will occur. The system is designed to identify documents that include a foreign currency and allows users to set target FX rates. A predictive model continuously checks current FX rates, compares them against the set targets, and automatically executes a transaction at the target rate to optimize the transaction. The predictive model transmits payments when the optimized rate is achieved. To mitigate the risk of unfavorable rate changes, the solution allows users to set a target loss rate. If the current rate falls below the loss target, the system will automatically buy currency and send payments. Users can also define the number of days to wait for the target FX rate before sending payments. Additionally, they can specify actions to be taken if the defined number of days elapses without achieving the target rate, such as proceeding with the payment or returning the payment to the pending list.

### Example System Environment

Referring now to Figure (FIG. 1, shown is a block diagram illustrating an embodiment of an example system environment 100 of a predictive model, in accordance with some embodiments. By way of example, the system environment 100 includes a computer server 110, a data store 115, and one or more user devices (generally, user device 120). The entities and components in the system environment 100 may communicate with each other through the network 180. In various embodiments, the system environment 100 may include fewer or additional components. The system environment 100 also may include different components. Also, while each of the components in the system environment 100 is described in a singular form, the system environment 100 may include one or more of each of the components. For example, there may be multiple user devices 120 that are associated with various users.

A computing server 110 may include one or more computing devices that perform various tasks related to extracting and providing data exchange rates, e.g., foreign exchange (FX) rate-related information. These tasks include identifying documents in one format, e.g., bills having foreign currency amount, monitoring a current value (e.g., FX rates or quantity in a measurement unit), and comparing them against target rates set by customers (e.g., maximizing or minimizing a conversion into another unit). The computing server 110 utilizes a predictive model to estimate the ideal time to execute a conversion and provide a corresponding result from that conversion. Additionally, the computing server 110 manages risk by checking if the conversion falls below the user-defined target loss rate and executing transactions accordingly. The computing server 110 also handles user-defined parameters, such as the number of days to wait for the target conversion transaction and the actions to be taken if the target conversion transaction is not met within the specified period.

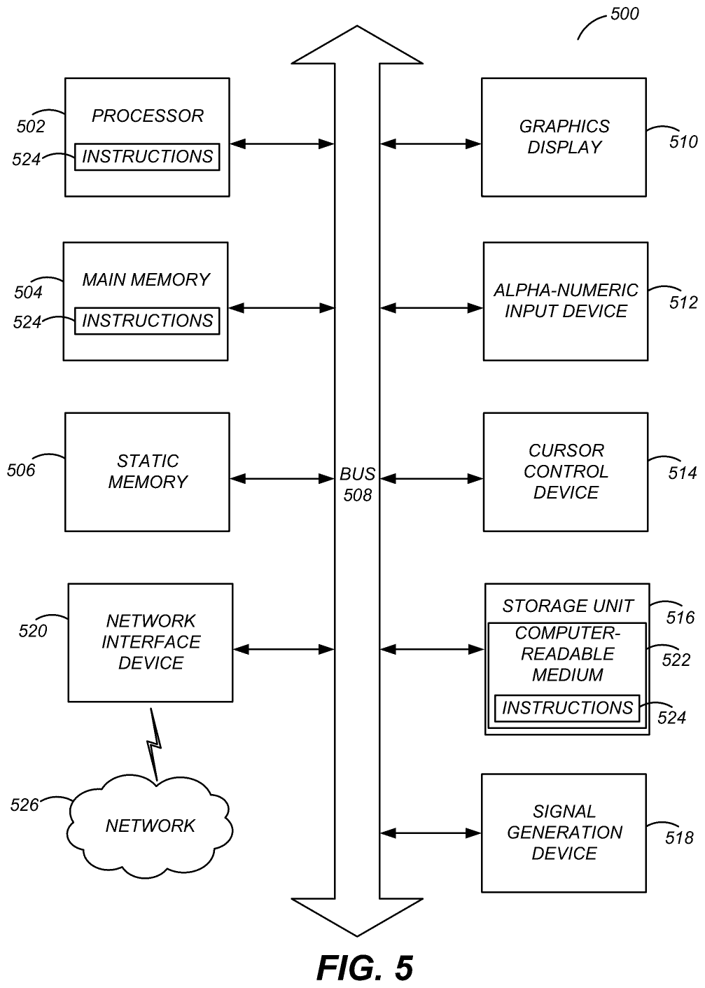

The computing server 110 may take the form of a combination of hardware and software. Some or all of the components of a computing machine of the computing server 110 is illustrated in FIG. 5. The computing server 110 may take different forms. In some embodiments, the computing server 110 may be a server computer that executes code instructions to perform various processes described herein. In other cases, the computing server 110 may be a pool of computing devices that may be located at the same geographical location (e.g., a server room) or be distributed geographically (e.g., clouding computing, distributed computing, or in a virtual server network). The computing server 110 may also include one or more virtualization instances such as a container, a virtual machine, a virtual private server, a virtual kernel, or another suitable virtualization instance. The computing server 110 may perform various tasks related to extracting and providing excavation-related information as a form of cloud-based software, such as software as a service (SaaS), through the network 180. Alternatively, or additionally, to the SaaS, the computing server 110 may provide on-premise software to certain organizations such as large construction contractors, utility companies and government agencies.

The data store 115 includes one or more storage units such as memory that takes the form of non-transitory and non-volatile computer storage medium to store various data that obtained by the computing server 110 or by various users of the computing server 110. For example, the data stored in data store 115 may include event data corresponding to value attributable to one or more real-world events, e.g., current events (i.e., political, economic, environmental, each of which may be assigned a numerical weighting and/or score), current and past FX rates, and previous weights assigned to a set of current events. The computer-readable medium is a medium that does not include a transitory medium such as a propagating signal or a carrier wave. The data store 115 may take various forms. In one embodiment, the data store 115 communicates with other components by the network 180. This type of data store 115 may be referred to as a cloud storage server. Example cloud storage service providers may include AMAZON AWS, DROPBOX, RACKSPACE CLOUD FILES, AZURE BLOB STORAGE, GOOGLE CLOUD STORAGE, etc. In another embodiment, instead of a cloud storage server, the data store 115 is a storage device that is controlled and connected to the computing server 110. For example, the data store 115 may take the form of memory (e.g., hard drives, flash memory, discs, ROMs, etc.) used by the computing server 110 such as storage devices in a storage server room that is operated by the computing server 110.

A user device 120 may be a computing device that can transmit and receive data via the network 180. The user device 120 also may be referenced as a client device. A user device 120 may be any computing device. Some or all of the components of a user device 120 is illustrated in FIG. 5. Examples of such user devices 120 include personal computers (PC), desktop computers, laptop computers, tablets (e.g., IPADs), smartphones, wearable electronic devices such as smartwatches, application-specific devices designed to be specifically used with the computing server 110, or any other suitable electronic devices.

Users of a user device 120 may include, but are not limited to, commercial entities, governmental entities (e.g., central banks or agencies), or individual users. A user also may be referred to as a client or an end user that communicates with the computing server 110 through a user device 120. The user device 120 may be referred to as a client device or an end user device. In some embodiments, a user device 120 includes one or more applications 122 and user interfaces 114 that may display visual elements of the applications 122.

An application 122 may be any suitable software application that operates at the user device 120. A user device 120 may include various applications 122 such as a software application provided by the computing server 110. The application 122 may provide a digital graph that displays data related to currency exchange rates FX over time. An application 122 may be of different types. In one case, an application 122 may be a web application that runs on JavaScript or other alternatives, such as TypeScript, etc. The application 122 may have a corresponding interface 124. In the case of a web application, the application 122 cooperates with a web browser to render a front-end interface 124. In another case, an application 122 may be a mobile application. For example, the mobile application may run on Swift for iOS and other APPLE operating systems or on JAVA or another suitable language for ANDROID systems. In yet another case, an application 122 may be a software program that operates on a desktop computer that runs on an operating system such as LINUX, MICROSOFT WINDOWS, MAC OS, or CHROME OS.

An interface 124 may be a suitable interface for an application to enable a user of a user device 120 to interact with computing server 110. The interface 124 may include various visualizations and graphical elements to display information for users and may also include input fields to accept inputs from users. A user may communicate to the application 122 and the computing server 110 through the interface 124. The interface 124 may take different forms. In one embodiment, the interface 124 may be a web browser such as CHROME, FIREFOX, SAFARI, INTERNET EXPLORER, EDGE, etc. and the application 122 may be a web application that is run by the web browser. In another application, the interface 124 is part of the application 122. For example, the interface 124 may be the front-end component of a mobile application or a desktop application. The interface 124 also may be referred to as a graphical user interface (GUI) which includes graphical elements to display a digital map and excavation-related information. In another embodiment, the interface 124 may not include graphical elements but may communicate with the computing server 110 via other suitable ways such as application program interfaces (APIs).

The network 180 provides connections to the components of the system environment 100 through one or more sub-networks, which may include any combination of the local area and/or wide area networks, using both wired and/or wireless communication systems. In one embodiment, a network 180 uses standard communications technologies and/or protocols. For example, a network 180 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 180 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 180 may be represented using any suitable format, such as hypertext markup language (HTML), extensible markup language (XML), JavaScript object notation (JSON), structured query language (SQL). In some embodiments, all or some of the communication links of a network 180 may be encrypted using any suitable technique or techniques such as secure sockets layer (SSL), transport layer security (TLS), virtual private networks (VPNs), Internet Protocol security (IPsec), etc. The network 180 also includes links and packet switching networks such as the Internet.

### Example Computing Server Components

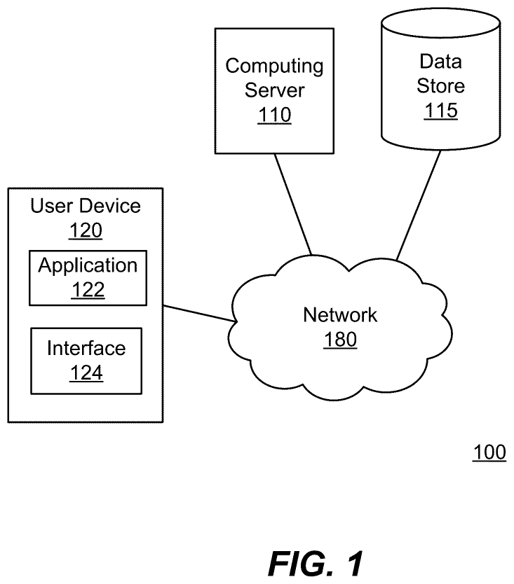

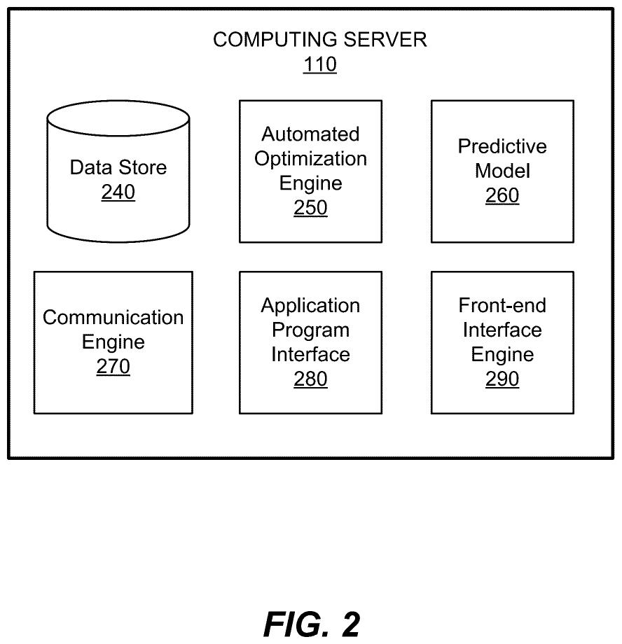

FIG. 2 is a block diagram illustrating various components of an example computing server 110, in accordance with some embodiments. In various embodiments, the computing server 110 may include fewer or additional components. The computing server 110 also may include different components. The functions of various components in the computing server 110 may be distributed in a different manner than described below. Moreover, while each of the components in FIG. 2 may be described in a singular form, the components may be present in plurality. Further, the components of the computing server 110 may be embodied as modules that include software (e.g., program code including instructions) that is stored on an electronic medium (e.g., memory) and executable by a processing system (e.g., one or more general processors). The components also could be embodied in hardware, e.g., field-programmable gate arrays (FPGAs) and/or application-specific integrated circuits (ASICs), that may include circuits alone or circuits in combination with firmware and/or software.

A computing server 110 may also integrate event data from third-party sources to enhance the accuracy of the predictive model. This event data can include geopolitical developments, economic indicators, market trends, and other relevant information that can influence foreign exchange rates.

A data store 240 may be a data store of the computing server 110 that is used to store data generated by the computing server 110, data obtained receiving event data from third party sources. Other data may include historical data associated with current and past trend measurement data, e.g., FX rates or quality of a commodity transaction. For example, historical FX data encompasses past trends, fluctuations, and patterns in FX rates over various time periods. The data store 240 includes non-transitory and non-volatile memory and may be an example of data store 115. The data store 240 may include unstructured data, semi-structured data, and structured data. Unstructured data may include raw data, event data, documents, and files. Semi-structured data may include various artificial intelligence models, machine learning models, and probability processing models, photos, user data and analytics. Structured data may include FX rate data, and other data converted to structured data. Various suitable data structures such as Structured Query Language (SQL), other relational database structures, and/or NoSQL that uses key-value pairs, wide columns, graphs, inversed indices, tabular stores, or resource description framework (RDF) may be used in the data store 240.

A predictive model 260 may be a machine learning model, a statistical model, an algorithm, or a combination of those that are used to estimate the ideal time at which a target foreign exchange (FX) rate will occur. The model leverages various types of data, including current FX rates, historical FX rates, and event data from third-party sources. By analyzing various types of data, the predictive model 260 identifies patterns, trends, and correlations that influence FX rate fluctuations. Machine learning models learn from vast amounts of data to improve their predictions over time, while statistical models use mathematical formulas to make estimations based on historical data. Algorithms may incorporate specific rules and logic to process the data and generate predictions. The combination of these approaches allows the predictive model 260 to provide users with accurate and timely recommendations for executing currency purchases and sending payments, optimizing for a time where the FX rate is equal to the target FX rates.

The predictive model 260 may use one or more machine learning algorithms, such as a regression model, a support vector machine, a random forest model, and a neural network, to determine the probability that the time at which a target foreign exchange (FX) rate will occur. The machine learning algorithms may be trained by a training set that includes various training samples. The predictive model 260 may apply a linear and non-linear regression model for baseline predictions of FX rates. The predictive model 260 may apply a support vector machine (SVM) to classify significant events that may impact FX rates. Further, the predictive model 260 may apply a deep learning model, including recurrent neural networks (RNNs) and long short-term memory (LSTM) networks, to capture complex temporal patterns and dependencies in the data. The predictive model 260 continuously updates to ingest and process incoming data streams in real-time to increase the model's adaptability and accuracy.

In one or more embodiments, the predictive model 260 integrates the weighted events into a forecasting framework. The predictive model 260 applies advanced time-series analysis techniques, such as autoregressive integrated moving average (ARIMA) models and vector autoregression (VAR), with machine learning predictions to forecast future FX rates. A VAR model applies a multivariate relationship between different time-series data points to forecast the FX rates based on various economic indicators. An ARIMA model captures temporal dependencies and trends in time-series data for handling the noise and seasonality of FX rates. As an example, for a series of events: A (political policy event), B (geopolitical event), and C (market trend event), the predictive model 260 may generate a forecast framework to predict the FX rate at a future time.

A communication engine 270 manages and estimates the communications between the computing server 110 and various entities that interact with it. These entities may include external data providers, financial institutions, and user devices. The communication engine ensures that the server can efficiently receive real-time foreign exchange (FX) rate data, historical data, and event data from third-party sources. It also handles the transmission of notifications and transaction confirmations to users. The communication engine 270 may include algorithms for various communication protocols and standards, encoding, decoding, multiplexing, traffic control, data encryption, etc. for various communication processes.

An application program interface (API) 280 of the computing server 110 exchanges data with various entities through computer code and programming language so that the exchange of information can be automated and conducted faster and with greater optimization for potential result sought. The API 280 may be for inbound information or for outbound information. For example, when the predictive model 260 determines that the target FX rate has been achieved, the API can automatically send a request to the bank's system to execute the currency purchase and initiate the payment. This automated exchange ensures that transactions are conducted swiftly and efficiently, minimizing delays and maximizing the chances of securing the desired FX rate. The API 280 may be in compliance with any common API standards such as Representational State Transfer (REST), query-based API, Webhooks, etc. The data transferred through the API 280 may be in formats such as JavaScript Object Notation (JSON) and Extensible Markup Language (XML).

A front-end interface engine 290 may provide an interface to transmit and display results, data, and digital graphs generated by the computing server 110. For example, data related to FX rates may be visualized as a digital graph. The front-end interface engine 290 may be in the form of a graphical user interface (GUI) to display the digital graph and allow users to provide inputs via the GUI. A user may manually input target loss and target gain FX rates through one or more interfaces in the graphical user interface (GUI). For example, a user may input a target gain rate for converting U.S. Dollar (USD) to European Euros (EUR) and a target loss rate for converting EUR to Japan Yen (JPY). The user interface allows the user to specify these target rates for different currency pairs, enabling the system to monitor the FX rates and execute transactions when the conditions are met. If the USD to EUR rate reaches the target gain rate, the system will automatically buy EUR. The front-end interface engine 290 may take different forms. In one embodiment, the front-end interface engine 290 may control an application 122 that is installed in a user device 120. For example, the application 122 may be a cloud-based SaaS or a software application that can be downloaded in an application store (e.g., APPLE APP STORE, ANDROID STORE). The front-end interface engine 290 may be a front-end software application that can be installed, run, and/or displayed at a user device 120 for users. The front-end interface engine 290 also may take the form of a webpage interface of the computing server 110 to allow users to access data and results through web browsers. In another embodiment, the front-end interface engine 290 may not include graphical elements but may provide other ways to communicate with a user, such as through APIs.

### Applying an Predictive Model to Optimize Operations

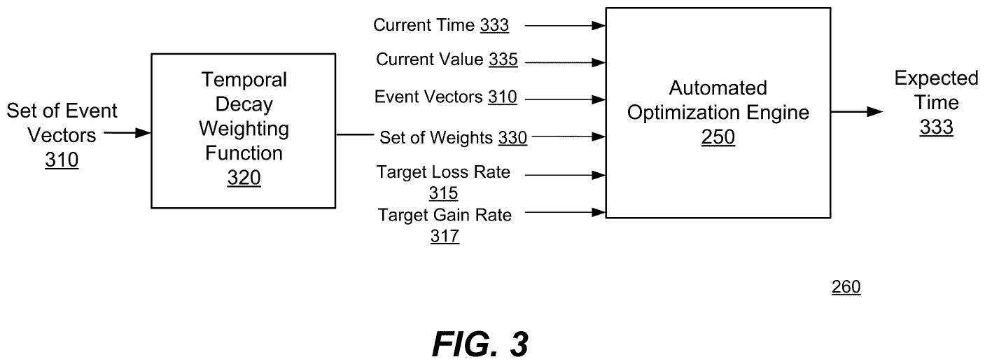

FIG. 3 is a block diagram illustrating a predictive model 260 for providing estimated weights for an received set of events, in accordance with some embodiments. The process 300 may be performed by a computer system such as the computing server 110 using one or more components discussed in FIG. 2, including the automated optimization engine 250. The computer system may be a single operation unit in a conventional sense (e.g., a single personal computer), a set of distributed computing devices that cooperate to execute a set of instructions, a Cloud computing device, a container, or a virtual machine and may have some or all of the components of the computer system described in FIG. 5. While the rest of the discussion in FIG. 3 will be described in association with the computing server 110 in a singular form, the computer or the computing server 110 here may include one or more computing systems (or devices).

The predictive model 260 receives a set of events, where an event is a signal generated in response to the occurrence of various economic or political factors, such as interest rates, inflation rates, trade balances, and political stability. The predictive model 260 classifies these events based on their nature (e.g., political, economic, social) to analyze a weight's impact on foreign exchange (FX) rates.

The predictive model 260 predicts a set of weights 330 for the events, where each weight is a numerical value assigned to represent the relative importance or significance of an event. A temporal decay weight function 320 maps a set of events to non-negative real numbers, facilitating the quantification of their impact. The temporal decay weight function 320 receives as input a set of event 320. The temporal decay weight function 320 assigns weights to events based on historical impact analysis. For example, an event for a central bank interest rate decision might be assigned a higher weight than an event for a minor political event. This may be determined because the historical weight for the event for a central bank's interest rate decision is higher than that of the latter event.

To adjust for the relevance of recent trends, the predictive model 260 may apply a temporal decay weight function 320 to determine the weight for each event 330, reducing the weight of older events over time. The predictive model may apply a decay function as a inverse time decay function with a factor to controls the rate of decay. This is achieved using a temporal decay function, denoted as d (t−ti), where t represents the current time and ti represents the time at which the event occurred and a factor k to control a decay factor. A higher value of k results in a faster decay, quickly reducing the importance of a weight over a time. For example, for an event A occurred 10 days ago, and the decay constant k, the decay factor for this event would be: d (t−ti)=1/(1+k*10). The temporal decay weighting function 320 applies an inverse time decay function by assigning a numerical value to each event based on its age relative to the current time. As a results, events that occurred recently receive higher weights, reflecting their greater potential impact on current FX rates, while older events gradually diminish in significance. The inverse time decay function reduces the weights of older events, ensuring that recent events are emphasized more in the predictive model. The temporal decay weighting function 320 focuses on current and more relevant data, enhancing the accuracy of FX rate predictions.

In one embodiment, to the system is configured to calculate a weight of an event to analyze relative to an impact on FX rate. For example, the predictive model 260 may calculates an average impact on FX rates for an event Wi over a time t and normalizes these impacts to ensure they are on a comparable scale. The weight for an event Wi at time t is given by Wi(t). In one embodiment,

$$Wi ( t ) = \frac{Impact \times d ( t - {t}_{i} )}{{Σ}_{j} Impact \times d ( t - {t}_{j} )}$$

where Impact is the historical impact of event i and d (t-t_i) is the decay function that adjusts the relevance of the event over time.

The computing server 110 receives a maximum loss rate, a target loss rate, as a critical threshold at which a predictive model 260 initiates an action. The target loss rate signifies a predetermined level of loss beyond which the computing server 110 automatically executes currency exchanges for bills denominated in foreign currencies. For instance, a user may set a maximum loss rate of 5% for converting Euros to US Dollars. If the actual exchange rate falls below this threshold during a trade, the system promptly executes the exchange to mitigate further losses. The target loss rate can be expressed either as an FX rate value or as a value of the quantity of bills traded by the FX rate, providing flexibility to users in defining their trading strategies.

The computing server 110 may also receive a minimum gain rate, a target gain rate, which serves as a threshold at which the predictive model 260 initiates an action in response to favorable conditions. The minimum gain rate represents the predetermined minimum level of gain that the user aims to achieve on a specific trade or portfolio involving foreign currency bills. For example, a user might set a minimum gain rate of 3% for converting USD to JPY. If the actual exchange rate rises above this threshold, the system automatically executes the exchange to lock in the gains. The target gain rate can be expressed either as an FX rate value or as a value of the quantity of bills traded by the FX rate, providing flexibility to users in defining their trading strategies.

In FIG. 3, the automated optimization engine 250 receives as input a current time 333, a current value of FX rate 335, event vectors 310, a set of weights 330, a target loss rate 315, and a target gain rate 317. The predicted set of weights 330 receive as input to an automated optimization engine 250.

The computing server 110 employs an automated optimization model 260 to predict the expected time at which the target loss rate or target gain rate is achieved for foreign currency exchanges. The automated optimization model 260 may receive as input: a current time 333, a current value of FX rate 335, event vectors 310, a set of weights 330, a target loss rate 315, and a target gain rate 317. These inputs are processed to predict the expected value of the FX rate over time. The automated optimization model 260 incorporates a forecasting function that dynamically adjusts based on real-time data, ensuring the predictions remain accurate and reflective of current market conditions. This function integrates the temporal decay of events' impacts, the historical significance of similar events, and the latest market trends to produce a reliable forecast. As an example, a function r_pred forecasts the expected FX rates at a future time t+Δt, based on current inputs. The function r_pred is represented by r_pred (t+Δt)=r(t)+Σw_i e_i*d (t-t_i). The r_pred function is a target FX rate function to predict a time at which a system executes an action for a target gain or loss rate. The function r_pred receives as input a current FX rate r (t), event vectors (e_i), a set of weights (w_i), and d (t−t_i) the decay function. The forecasting function r_pred iterates over time to find a point where the identified time is a time at which a current FX rate meets or exceeds the target gain rate or the target loss rate.

The automated optimization model 260 predicts the expected time at which the target loss rate or target gain rate is achieved for foreign currency exchanges. The function within the automated optimization model 260 calculates the expected time at with a target loss rate or target gain rate is achieved by analyzing set of weights 330 associated with an event 310 and applying a time-dependent decay factor. Once the expected value is determined, the automated optimization model 260 applies the function to identify the specific time when this expected value meets either the target loss rate 315 or the target gain rate 317. By accurately predicting the expected times, the computing server 110 can proactively execute trades to either minimize losses or secure gains of the user-defined thresholds and to optimize the trading strategy.

### Example Process for Determining Mark Location Data

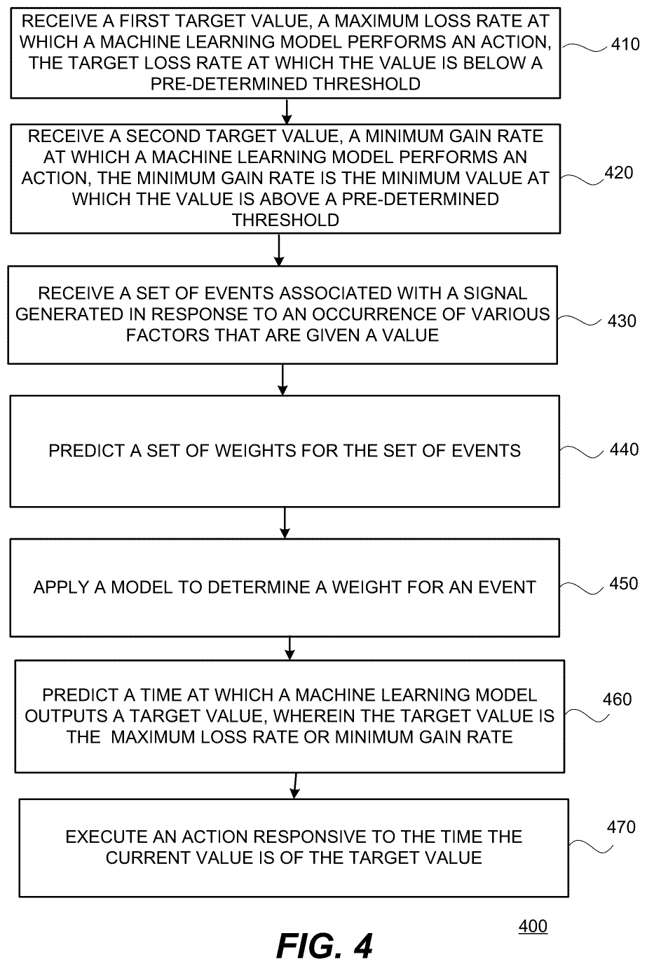

FIG. 4 is a flowchart that depicts an example process 400 for predicting a time at which a predictive model outputs an targeted optimal result, e.g., maximum loss rate or minimum gain rate. The process 400 may be implemented by a computer system, which may be a single operation unit in a conventional sense (e.g., a single personal computer) or may be a set of distributed computing devices that cooperate to execute a set of instructions (e.g., a virtual machine, a distributed computing system, Cloud computing, etc.). In one case, the computer system may be a computing server 110 that may include one or more of the components of the computer system described with FIG. 5, e.g., a memory and a processor system having one or more processors. The memory may store computer code that includes instructions. The instructions, when executed by the processor system, may cause the processor system to perform (or execute) various steps described herein. Also, while the computer system is described in a singular form, the computer system that performs the process in FIG. 4 may include more than one computer that is associated with the computing server 110.

In accordance with some embodiments, a computing server 110 receives 410 a first target value, e.g., loss rate, at which a machine learning model performs an action. In this example, a target loss rate at which the value is below a pre-determined threshold. The computing server 110 receives 420 a second target value, e.g., a target gain rate, at which an action is to be performed. The target gain rate is the minimum value at which the predicted exchange value is above a pre-determined threshold. The computing server 110 receives 430 a set of events associated with a signal generated in response to an occurrence of various factors that are given a value. For example, in the case of FX rate, the factors may include economic political factors that are assigned a value by the system. The value may be assigned based on historical data, severity of the event, geolocation, as well as surrounding events that may impact the factor being valued. The computing server 110 predicts 440 a set of weights for each of the received set of events. The computing server 110 applies 450 a model to determine a weight for the set of events. The model may be trained to reduce the weight of the older events over time to emphasize recent trends. The computing server 110 predicts 460 a time at which a machine learning model outputs a target value e.g. the maximum loss rate, or the minimum gain rate. The computing server 110 executes 470 an action responsive to the time at which the current rate is of the target value.

### Details on the Machine Learning Model

In various embodiments, a wide variety of machine learning techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used.

In various embodiments, the training techniques for a machine learning model may be supervised, semi-supervised, or unsupervised. In supervised learning, the machine learning models may be trained with a set of training samples that are labeled. For example, for a machine learning model trained to classify objects, the training samples may be different images of objects labeled with the type of objects. The labels for each training sample may be binary or multi-class. In some cases, an unsupervised learning technique may be used. The samples used in training are not labeled. Various unsupervised learning technique such as clustering may be used. In some cases, the training may be semi-supervised with training set having a mix of labeled samples and unlabeled samples.

A machine learning model may be associated with an objective function, which generates a metric value that describes the objective goal of the training process. For example, the training may intend to reduce the error rate of the model in generating predictions. In such a case, the objective function may monitor the error rate of the machine learning model. In object recognition (e.g., object detection and classification), the objective function of the machine learning algorithm may be the training error rate in classifying objects in a training set. Such an objective function may be called a loss function. Other forms of objective functions may also be used, particularly for unsupervised learning models whose error rates are not easily determined due to the lack of labels. In image segmentation, the objective function may correspond to the difference between the model's predicted segments and the manually identified segments in the training sets. In various embodiments, the error rate may be measured as cross-entropy loss, L1 loss (e.g., the sum of absolute differences between the predicted values and the actual value), L2 loss (e.g., the sum of squared distances).

### Computing Machine Architecture

FIG. 5 is a block diagram illustrating components of an example computing machine that is capable of reading instructions from a computer-readable medium and execute them in a processor (or controller). A computer described herein may include a single computing machine shown in FIG. 5, a virtual machine, a distributed computing system that includes multiples nodes of computing machines shown in FIG. 5, or any other suitable arrangement of computing devices.

By way of example, FIG. 5 shows a diagrammatic representation of a computing machine in the example form of a computer system 500 within which instructions 524 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing system described in FIG. 5 may correspond to any software, hardware, or combined components shown in FIGS. 1 and 2, including but not limited to the computing server 110, the user device 120 and various engines, interfaces, terminals, and machines shown in FIG. 2. While FIG. 5 shows various hardware and software elements, each of the components described in FIG. 1 or FIG. 2 may include additional or fewer elements.

By way of example, a computing machine may be a personal computer (PC), a tablet PC, a smartphone, a web appliance, a network router, an internet of things (IoT) device, a switch or bridge, or any machine capable of executing instructions 524 that specify actions to be taken by that machine. Further, while only a single machine is illustrated, the term “machine” and “computer” may also be taken to include any collection of machines that individually or jointly execute instructions 524 to perform any one or more of the methodologies discussed herein.

The example computer system 500 includes a processor system having one or more processors 502 such as a CPU (central processing unit), a GPU (graphics processing unit), a TPU (tensor processing unit), a DSP (digital signal processor), a system on a chip (SOC), a controller, a state machine, an application-specific integrated circuit (ASIC), a field-programmable gate array (FPGA), or any combination of these. Parts of the computing system 500 may also include a memory 504 that store computer code including instructions 524 that may cause the processors 502 to perform certain actions when the instructions are executed, directly or indirectly by the processors 502. Instructions can be any directions, commands, or orders that may be stored in different forms, such as equipment-readable instructions, programming instructions including source code, and other communication signals and orders. Instructions may be used in a general sense and are not limited to machine-readable codes.

One and more methods described herein improve the operation speed of the processors 502 and reduces the space required for the memory 504. For example, the machine learning methods described herein reduces the complexity of the computation of the processors 502 by applying one or more novel techniques that simplify the steps in training, reaching convergence, and generating results of the processors 502. The algorithms described herein also reduces the size of the models and datasets to reduce the storage space requirement for memory 504.

The performance of certain of the operations may be distributed among the more than processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 500 may include a main memory 504, and a static memory 506, which are configured to communicate with each other via a bus 508. The computer system 500 may further include a graphics display unit 510 (e.g., a plasma display panel (PDP), a liquid crystal display (LCD), a projector, or a cathode ray tube (CRT)). The graphics display unit 510, controlled by the processors 502, displays a graphical user interface (GUI) to display one or more results and data generated by the processes described herein. The computer system 500 may also include an alphanumeric input device 512 (e.g., a keyboard), a cursor control device 514 (e.g., a mouse, a trackball, a joystick, a motion sensor, or another pointing instrument), a storage unit 516 (a hard drive, a solid state drive, a hybrid drive, a memory disk, etc.), a signal generation device 518 (e.g., a speaker), and a network interface device 520, which also are configured to communicate via the bus 508.

The storage unit 516 includes a computer-readable medium 522 on which is stored instructions 524 embodying any one or more of the methodologies or functions described herein. The instructions 524 may also reside, completely or at least partially, within the main memory 504 or within the processor 502 (e.g., within a processor's cache memory) during execution thereof by the computer system 500, the main memory 504 and the processor 502 also constituting computer-readable media. The instructions 524 may be transmitted or received over a network 526 via the network interface device 520.

While computer-readable medium 522 is shown in an example embodiment to be a single medium, the term “computer-readable medium” should be taken to include a single medium or multiple media (e.g., a centralized or distributed database, or associated caches and servers) able to store instructions (e.g., instructions 524). The computer-readable medium may include any medium that is capable of storing instructions (e.g., instructions 524) for execution by the processors (e.g., processors 502) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Embodiments according to the invention are in particular disclosed in the attached claims directed to a method and a computer program product, wherein any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject-matter which can be claimed comprises not only the combinations of features as set out in the disclosed embodiments but also any other combination of features from different embodiments. Various features mentioned in the different embodiments can be combined with explicit mentioning of such combination or arrangement in an example embodiment. Furthermore, any of the embodiments and features described or depicted herein can be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In one embodiment, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even if other steps are claimed or described first in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

What is claimed is:

1. A computer-implemented method for providing an event information, the computer-implemented method comprising:
receiving a first target value for a maximum loss rate at which a machine learning model performs an action, wherein the target loss rate at which the value is below a pre-determined threshold;
receiving a second target value for a minimum gain rate at which a machine learning model performs an action, wherein the target gain rate at which the value is above a pre-determined threshold;
receiving a set of events associated with a signal generated in response to an occurrence of various factors that are given a value;
predicting a set of weights for the set of events;
adjusting for a relevance of a current event by applying a decay function to reduce the weight value of an event over time;
predicting a time at which the machine learning model outputs a target value, wherein the target value is the maximum loss rate or minimum gain rate; and
executing an action responsive to the time the current value is of the target value.

2. The computer-implemented method of claim 1, wherein the set of events are a signal generated in response to the occurrence of various economic or political factors.

3. The computer-implemented method of claim 1, wherein the set of weights for the received set of events is a numerical value assigned to represent a relative importance or significance of an event.

4. The computer-implemented method of claim 1, wherein predicting a set of weights for the set of events further comprises:
applying a weight function to assign weights to events based on historical impact analysis; and
mapping the set of events to non-negative real numbers.

5. The computer-implemented method of claim 1, wherein the decay model for reducing weight is a temporal decay function, a linear decay function, or an inverse time decay function.

6. The computer-implemented method of claim 1, wherein an action includes but is not limited to purchasing a FX rate value for the predicted time, submitting a notification to a user, or logging the FX rate value.

7. The computer-implemented method of claim 1, wherein the rate value is a currency exchange rate FX between two foreign country currencies.

8. The computer-implemented method of claim 1, wherein the machine learning model receives as input a received set of events, weights associated with the set of events, current rate values, a current time, the target loss rate, and the target gain rate.

9. A computer program product for providing an event information, the computer program product stored on a non-transitory computer readable medium and including instructions configured to cause one or more processors to execute steps comprising:
receiving a first target value for a maximum loss rate at which a machine learning model performs an action, wherein the target loss rate at which the value is below a pre-determined threshold;
receiving a second target value for a minimum gain rate at which a machine learning model performs an action, wherein the target gain rate at which the value is above a pre-determined threshold;
receiving a set of events associated with a signal generated in response to an occurrence of various factors that are given a value;
predicting a set of weights for the set of events;
adjusting for a relevance of a current event by applying a decay function to reduce the weight value of an event over time;
predicting a time at which the machine learning model outputs a target value, wherein the target value is the maximum loss rate or minimum gain rate; and
executing an action responsive to the time the current value is of the target value.

10. The computer program of claim 9, wherein the set of events are a signal generated in response to the occurrence of various economic or political factors.

11. The computer program of claim 9, wherein the set of weights for the received set of events is a numerical value assigned to represent a relative importance or significance of an event.

12. The computer program of claim 9, wherein predicting a set of weights for the set of events further comprises:
applying a weight function to assign weights to events based on historical impact analysis; and
mapping the set of events to non-negative real numbers.

13. The computer program of claim 9, wherein the decay model for reducing weight is a temporal decay function, a linear decay function, or an inverse time decay function.

14. The computer program of claim 9, wherein an action includes but is not limited to purchasing a FX rate value for the predicted time, submitting a notification to a user, or logging the FX rate value.

15. The computer program of claim 9, wherein the rate value is a currency exchange rate FX between two foreign country currencies.

16. The computer program of claim 9, wherein the machine learning model receives as input a received set of events, weights associated with the set of events, current rate values, a current time, the target loss rate, and the target gain rate.

17. A non-transitory computer-readable storage medium comprising stored computer program code, the program code comprising instructions executable by one or more processors of a computing system to perform steps comprising:
receiving a first target value for a maximum loss rate at which a machine learning model performs an action, wherein the target loss rate at which the value is below a pre-determined threshold;
receiving a second target value for a minimum gain rate at which a machine learning model performs an action, wherein the target gain rate at which the value is above a pre-determined threshold;
receiving a set of events associated with a signal generated in response to an occurrence of various factors that are given a value;
predicting a set of weights for the set of events;
adjusting for a relevance of a current event by applying a decay function to reduce the weight value of an event over time;
predicting a time at which the machine learning model outputs a target value, wherein the target value is the maximum loss rate or minimum gain rate; and
executing an action responsive to the time the current value is of the target value.

18. The non-transitory computer-readable storage medium of claim 17, wherein the set of events are a signal generated in response to the occurrence of various economic or political factors.

19. The non-transitory computer-readable storage medium of claim 17, the steps further comprising, wherein the set of weights for the received set of events is a numerical value assigned to represent a relative importance or significance of an event.

20. The non-transitory computer-readable storage medium of claim 17, wherein predicting a set of weights for the set of events further comprises:
applying a weight function to assign weights to events based on historical impact analysis; and
mapping the set of events to non-negative real numbers.
